(19) United States
(12) Patent Application Publication
(10) Pub. No.: US 2009/0296547 A1
(43) Pub. Date: Dec. 3, 2009

(54) Information Recording Apparatus and Information Recording Program

(76) Inventor: Hirokazu Hirose, Saitama (JP)

Correspondence Address: DRINKER BIDDLE & REATH (DC), 1500 K STREET, N.W., SUITE 1100, WASHINGTON, DC, 20005-1209, US

(21) Appl. No.: 11/922,133

(22) PCT Filed: May 16, 2006
(86) PCT No.: PCT/JP2006/309749

§ 371 Date: Dec. 13, 2007

(30) Foreign Application Priority Data
Jun. 16, 2005 (JP) 2005-176716

(51) Int. Cl. G11B 7/00; G11B 3/74

(52) U.S. Cl. 369/53.2; 369/94; G9B/7; G9B/3.108

(57) ABSTRACT

The present invention provides an information recording apparatus capable of reproducing recorded recording information without giving strange feeling even in the case where it is necessary to switch a recording layer among multiple recording layers, and an information recording program for executing the information recording process.

An information recording apparatus R for recording “recording information Sr” to an optical disk DK having a plurality of recording layers L0 and L1 has a CPU 4 for detecting the content of the recording information Sr during recording of the recording information Sr to the recording layer L0, on the basis of the detected content, switching the recording layer L0 to which the recording information Sr is switched to the recording layer L1, and continuing recording of the recording information Sr.

### TECHNICAL FIELD

The present invention belongs to the technical field of an information recording apparatus and an information recording program. More particularly, the invention belongs to the technical field of an information recording apparatus for recording information to a recording medium having a plurality of recording layers and an information recording program for executing the information recording process.

### BACKGROUND ART

In recent years, in association with start of digital terrestrial broadcasting and the like, a demand for increasing recording capacity of a recording medium such as an optical disk is conspicuous, and research and development on multi-layering of a recording medium as one of solutions is actively performed. In the multi-layering, for example, in the case of an optical disk, a plurality of recording layers are stacked and recording information is recorded on each of the recording layers. With respect to recording information of an information amount exceeding the recording capacity of one recording layer, obviously, continuous recording information is recorded on a plurality of recording layers.

For example, in the case of recording “recording information” on a plurality of recording layers stacked, at the time of reproduction, an information detection position has to be moved from one recording layer to another recording layer. For example, in the case where an instruction of interlayer seamless (continuous) reproduction is not given, reproduction from the recording medium of the recording information is temporarily interrupted during the movement.

A conventional multilayer recording medium generally has a configuration that when recording of recording information is finished to the termination end of a recording area in one recording layer, the recording layer is switched to another recording layer, and the remaining recording information is recorded.

### DISCLOSURE OF THE INVENTION

### Problem to be solved by the Invention

With the conventional configuration, however, when recording is finished to a physical termination end of a recording area in one recording layer, the recording layer is switched to another recording layer. Consequently, there is a problem such that, at the time of reproducing the recorded recording information, reproduction is interrupted by switching of the recording layer at a timing at which interruption of the reproduction is undesirable from the viewpoint of the content.

The problem causes another problem such that, in the case where recording information has an attribute that recording cannot be performed again such as the case where recording information is, for example, a program being broadcasted, a serious influence is exerted on the value of the recording information according to content such as a scene at the switching timing.

The present invention has been achieved in consideration of the problems and an object of the invention is to provide an information recording apparatus capable of reproducing recorded recording information without giving strange feeling even in the case where there is necessity of switching a recording layer among multiple recording layers and an information recording program for executing the information recording process.

### Means for Solving the Problem

In order to solve the above problem, the invention of claim 1 relates to an information recording apparatus for recording “recording information” to a recording medium having a plurality of recording layers, comprising:

content detecting means for detecting content of the recording information during recording of the recording information to one of the recording layers; and

switching means for switching the recording layer to which the recording information is recorded from the one recording layer to another recording layer on the basis of the detected content, and continuing recording of the recording information.

In order to solve the above problem, the invention of claim 11 relates to an information recording program for making a computer included in an information recording apparatus for recording “recording information” to a recording medium having a plurality of recording layers function as:

content detecting means for detecting content of the recording information during recording of the recording information to one of the recording layers; and

switching means for switching the recording layer to which the recording information is recorded from the one recording layer to another recording layer on the basis of the detected content, and continuing recording of the recording information.

### BRIEF DESCRIPTION OF THE DRAWINGS

FIG. 1 is a block diagram showing a schematic configuration of an information recording apparatus of an embodiment.

FIG. 2 is a flowchart showing a recording process in the embodiment.

### DESCRIPTION OF REFERENCE NUMERALS

1 pickup
2 encoding unit
4 CPU
5 display unit
6 operation unit
7 servo processing unit
DK optical disk
L0, L1 recording layers

### BEST MODE FOR CARRYING OUT THE INVENTION

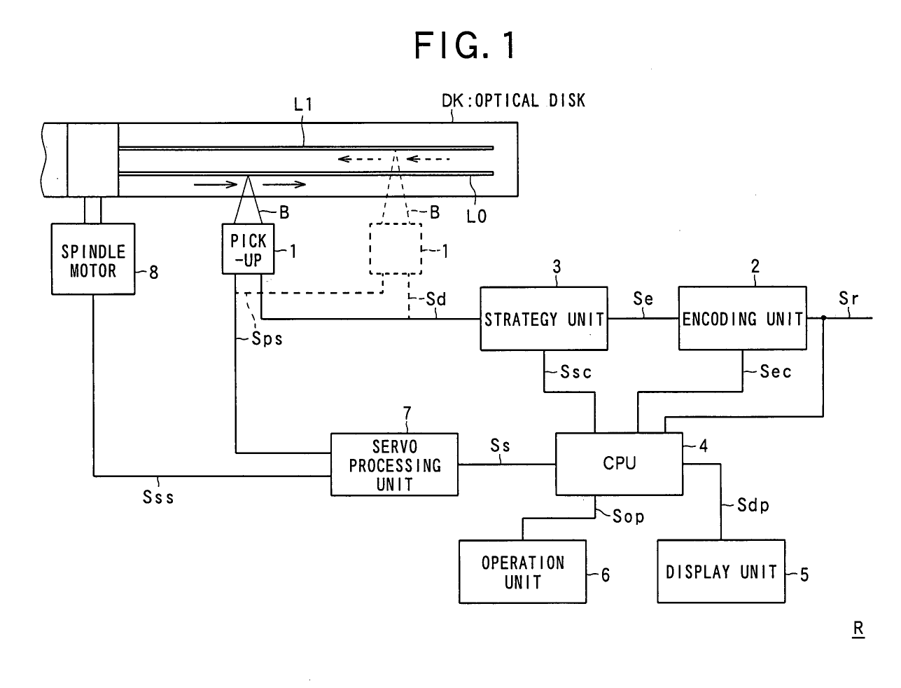

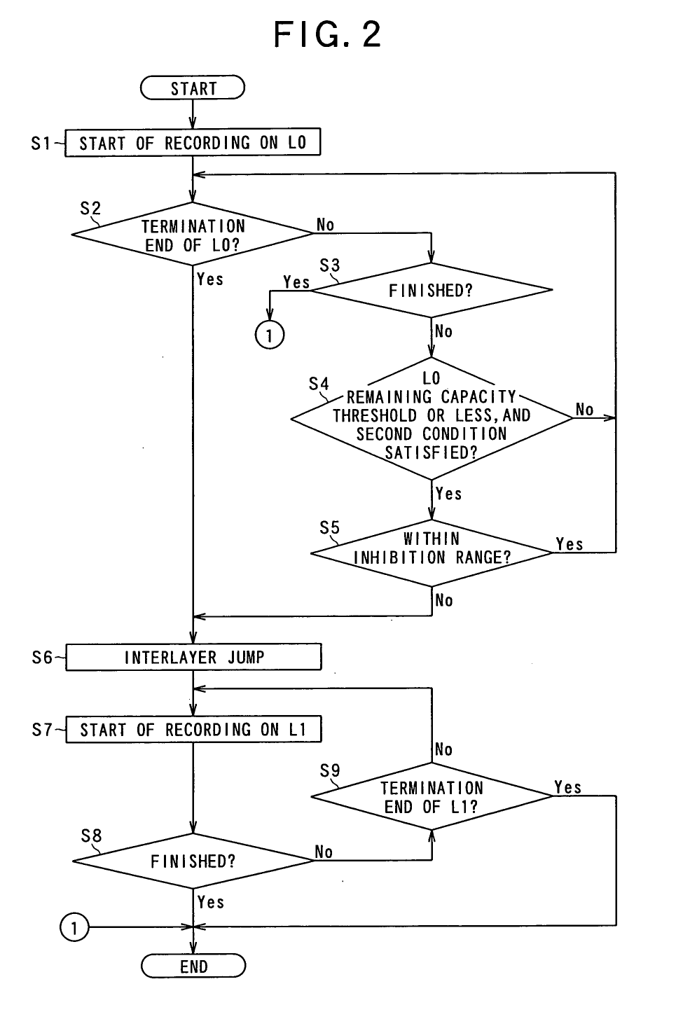

A best mode for carrying out the present invention will be described with reference to FIGS. 1 and 2.

An embodiment described below relates to a case of applying the present invention to an information recording apparatus for optically recording information to each of two recording layers formed in an optical disk. FIG. 1 is a block diagram showing a schematic configuration of an information recording apparatus of the embodiment, and FIG. 2 is a flowchart showing the operation of the information recording apparatus.

### (I) General Description

First, a general configuration and operation of an information recording apparatus S of the embodiment will be described.

As shown in FIG. 1, the information recording apparatus S of the embodiment is constructed by a pickup 1 integrally formed with a not-shown carriage, an encoding unit 2, a strategy unit 3, a CPU 4 as content detecting means, control means, remaining recording capacity detecting means, and switching means, a display unit 5 such as a liquid crystal display, an operation unit 6 as inhibition range setting means formed by an operation button, an infrared remote controller, or the like, a servo processing unit 7, and a spindle motor 8.

The operation will now be described.

First, in an optical disk DK of the embodiment, two parallel recording layers L0 and L1 are formed, and information can be optically recorded in each of the recording layers L0 and L1 with a light beam B. In the recording layer L0, as shown in FIG. 1, information is recorded spirally from the inner radius side of the optical disk DK toward the outer radius side. On the other hand, in the recording layer L1, information is recorded spirally from the outer radius side of the optical disk DK toward the inner radius side. When information is recorded to the termination end of the outer radius side in the recording layer L0, the light condensing position of the light beam B is moved from the termination end of the outer radius side in the recording layer L0 to the start end of the outer radius side of the recording layer L1. After that, information is recorded in the recording layer L1 from the outer radius side toward the inner radius side. In the following description, the movement of the light condensing position from the recording layer L0 to the recording layer L1 will be called an “interlayer jump”.

The center of the optical disk DK having the above-described configuration is fixed to the spindle motor 8, and the optical disk DK is rotated by the spindle motor 8 at preset rotational speed for recording. The rotational speed is controlled on the basis of a servo signal Sss from the servo processing unit 7.

On the other hand, recording information Sr to be recorded on the optical disk DK is input from the outside and output to the encoding unit 2 and the CPU 4. On the basis of a control signal Sec from the CPU 4, the information is encoded by the encoding unit 4 by an encoding method according to the kind of the optical disk DK (for example, a CD (Compact Disc), a DVD (Digital Versatile Disc), or the like), and the encoded information is output as encoded information Se to the strategy unit 3.

Next, on the basis of a control signal Ssc from the CPU 4, the strategy unit 3 shapes the waveform of the encoded information Se in accordance with a recording method in the optical disk DK (for example, a recording method capable of recording information only once using dye films as the recording layers L0 and L1, a rewritable recording method using phase-change films as the recording layers L0 and L1, or the like) and outputs the resultant signal as a recording signal Sd to the pickup 1.

When a not-shown semiconductor laser in the pickup 1 is driven on the basis of the recording signal Sd, a light beam B whose intensity is modulated in correspondence with the recording signal Sd is emitted to the recording layer L0 or L1 to form a recording pit corresponding to the recording signal Sd onto the recording layer L0 or L1, thereby optically recording the recording information Sr onto the optical disk DK.

In the recording process, a not-shown focus actuator or tracking actuator in the pickup 1 is driven on the basis of a servo signal Sps from the servo processing unit 7 to move a not-shown objective lens for condensing the light beam B, thereby controlling the irradiation position and the interlayer jump of the light beam B. Since the information recording directions in the recording layers L0 and L1 are different from each other as described above, in the case of recording information to the recording layer L0, the pickup 1 is moved from the inner radius side of the optical disk DK toward the outer radius side as shown by a solid line in FIG. 1. On the other hand, in the case of recording information to the recording layer L1, the pickup 1 is moved from the outer radius side of the optical disk DK toward the inner radius side as shown by a broken line in FIG. 1.

Consequently, on the basis of a control signal Ss from the CPU 4, the servo processing unit 7 generates the two servo signals Sss and Sps and outputs them to the spindle motor 8 and the pickup 1, respectively. At this time, the interlayer jump is performed by a method which will be described later with reference to FIG. 2.

To perform centralized control on operations of the components described above, the CPU 4 generates the control signals Sec, Ssc, and Ss on the basis of an operation signal Sop output from the operation unit 6 according to an operation of the user and outputs the control signals to the encoding unit 2, the strategy unit 3, and the servo processing unit 7. The operation state of the information processing apparatus S is displayed on the display unit 5 on the basis of a display signal Sdp from the CPU 4.

Further, the CPU 4 executes a recording process of the embodiment which will be described later on the basis of the recording information Sr directly input from the outside.

Next, a recording process including the interlayer jump of the embodiment, executed in the information recording apparatus S having the above-described configuration will be concretely described with reference to FIG. 2.

In the recording process of the embodiment, in addition to whether the irradiation position of the light beam B has reached the termination end on the outer radius side of the recording layer L0 or not is determined in order to determined whether the interlayer jump is executed or not, the recording information Sr itself is also reflected.

Specifically, as shown in FIG. 2, recording of information to the optical disk DK is started from the start end of the inner radius side of the recording layer L0 (step S1).

While recording is performed on the recording layer L0, whether the irradiation position of the light beam B (that is, information recording position) has reached to the termination end on the outer radius side of the recording layer L0 or not is monitored (step S2). When the irradiation position of the light beam B has not reached to the termination end on the outer radius side of the recording layer L0 (step S2; NO), whether all of the recording information Sr to be recorded has been recorded or not is determined (step S3). When all of the recording information Sr to be recorded in the recording layer L0 has been recorded (step S3; YES), the recording process of the embodiment is finished.

When it is determined in step S2 that the irradiation position of the light beam B has reached the termination end of the outer radius side of the recording layer L0 (step S2; YES), the CPU 4 moves to the process of step S6 which will be described later and performs the interlayer jump.

On the other hand, when it is determined in step S3 that the recording of the recording information Sr to the recording layer L0 has to be continued (step S3; NO), next, a check is made to see whether or not remaining recordable capacity in the recording layer L0 becomes equal to or less than a preset threshold and whether a second condition which will be described later on the recording information Sr is satisfied or not (step S4). The threshold is preset as, for example, recording capacity as 10% of the whole recording capacity in the recording layer L0. The second condition will be described in detail later.

When it is determined in step S4 that the remaining recordable capacity in the recording layer L0 is not equal to or less than the threshold or the second condition is not satisfied (step S4; NO), recording on the recording layer L0 is continued.

On the other hand, when it is determined in step S4 that the remaining recordable capacity in the recording layer L0 is equal to or less than the threshold and the second condition is satisfied (step S4; YES), a check is made to see whether or not the recording information Sr belonging to an interlayer jump inhibition range which is preset according to the recording information Sr (step S5).

When the recording information Sr belonging to the inhibition range is being recorded (step S5; YES), without performing the interlayer jump, recording of information on the recording layer L0 is continued.

On the other hand, when the recording information Sr belonging to the inhibition range is not being recorded (step S5; NO), even in the case where the irradiation position of the light beam B has not reached to the termination end on the outer radius side of the recording layer L0, the interlayer jump from the recording layer L0 to the recording layer L1 is made (step S6). After that, recording of the recording information Sr to the recording layer L1 is started (step S7). The inhibition range will be also described in detail later.

A check is made to see whether all of the recording information Sr to be recorded has been recorded or not (step S8). When the recording information Sr to be recorded has been recorded on the optical disk DK (step S8; YES), the recording process of the embodiment is finished.

On the other hand, when it is determined in step S8 that the recording of the recording information Sr on the recording layer L1 has to be continued (step S8; NO), next, a check is made to see whether or not the irradiation position of the light beam B has reached the termination end of the inner radius side of the recording layer L1 (step S9). When the irradiation position of the light beam B has not reached the termination end of the inner radius side of the recording layer L1 (step S9; NO), the recording of the recording information Sr to the recording layer L1 is continued.

On the other hand, when the irradiation position of the light beam B has reached the termination end of the inner radius side of the recording layer L1 (step S9; YES), since it is impossible to record the recording information Sr to the optical disk DK any more, the recording process of the embodiment is finished.

### (II) Detailed Description of Second Condition

Next, as the details of the embodiment, the second condition for determining the recording information Sr in the CPU 4 will be described in detail.

As the second condition for determining the recording information Sr in the CPU 4, concretely, the following conditions (1) to (7) can be mentioned.

(1) Whether it is any hour, that is, any of midnight, one o'clock, two o'clock, . . . , and 23 o'clock.
(2) For example, whether or not it is half past any hour, specifically, 0:30, 1:30, 2:30, . . . and 23:30.
(3) When the recording information Sr is, for example, a television broadcast program including sound information, whether or not silence has continued for preset threshold time (for example, two seconds) or longer in the recording information Sr.
(4) When the recording information Sr is, for example, a television broadcast program including moving picture information, whether or not a picture as a motion picture in the recording information Sr has changed as a whole.
(5) When the recording information Sr is, for example, television broadcast program including moving picture information, whether an aspect ratio of a moving picture in the recording information Sr has changed or not.
(6) When the recording information Sr includes copyright information, the content of the copyright information (for example, information can be copied only once or copy free) has changed or not (including the presence or absence of the copyright information itself).
(7) When the recording information Sr is, for example, a television broadcast program and a corresponding broadcast program listing can be obtained in advance by the information recording apparatus S, whether or not the attribute of sound (for example, stereo broadcasting or not) as the recording information Sr indicted in the broadcast program listing and the attribute of sound as the recording information Sr detected in the CPU 4 are different from each other.

Among the conditions, first, with respect to the condition (1), for example, in television broadcasting, in many cases, a program changes or a commercial is broadcasted every hour. Consequently, the timing is employed as the timing of the interlayer jump.

Next, with respect to the condition (2), like the condition (1), in many cases, a program changes or a commercial is broadcasted every 30 minutes. Consequently, the timing is employed as the timing of an interlayer jump.

Further, with respect to the condition (3), a silent part is expected as an not-influencing scene in story as the recording information Sr as a silence part, so that the timing is employed as a timing of an interlayer jump.

As the condition (4), when the whole picture as a moving picture is changed, usually, the possibility that a large scene change occurs or broadcasting has changed to a commercial part is high. Consequently, the timing is employed as the timing of an interlayer jump.

Next, with respect to the condition (5), when the aspect ratio of a moving picture has changed, usually, the possibility that a program itself has changed or broadcasting has changed to a commercial part is high. Consequently, the timing is employed as the timing of the interlayer jump.

Further, with respect to the condition (6), when the content of the copyright information changes, usually, the possibility that a program itself has changed or broadcasting has changed to a commercial part is high. Consequently, the timing is employed as the timing of the interlayer jump.

Finally, with respect to the condition (7), when the attribute of a sound is different from that in a broadcast program listing, usually, the possibility that a broadcasting has changed to a commercial part is high. Consequently, the timing is employed as the timing of the interlayer jump.

The above-described conditions (1) to (7) are used mutually in parallel as the second-condition; When one of the seven conditions is satisfied, it is determined in the step S4 that the second condition is satisfied.

The seven conditions may be determined not in parallel but in series. That is, the conditions may be applied with priority, or the priority may be varied according to the attribute of the input recording information Sr.

Further, the condition (1) or (2) and the content of the broadcast program listing (concretely, start time and end time of each of programs) may be combined and every hour or every half past every hour at which there is no possibility that the program changes may be excluded from the second condition.

Further, in addition to the condition (3), a single color of an image (for example, so-called blue background or black) and silent time may be set as the second condition.

In the case where there is an interlayer jump timing designated in advance by the user with the operation unit 6, whether the designated timing has arrived or not may be set as the second condition, or the timing may be determined preferentially over the other conditions.

### (III) Detailed Description of Inhibition Range

Next, as the details of the embodiment, an inhibition range used for determination in the step S5 will be described in detail.

The inhibition range is a range in which the interlayer jump is not allowed during recording of the recording information Sr included in the period, in other words, the range of the recording information Sr in which continuity of the recording information Sr is lost when an interlayer jump occurs at the time of reproducing the recorded recording information Sr.

As the inhibition range, concretely, for example, a period in which output level of sound included as the recording information Sr is equal to or larger than a preset threshold is regarded as a characteristic range in which the recording information Sr is to be continuously reproduced. It is desirable to inhibit an interlayer jump during the period.

The determination in the step S5 is not always necessary. The determination can be selectively performed according to setting of the user or the attribute of the input recording information Sr.

As described above, by the operation of the information recording apparatus S of the embodiment, at the time of an interlayer jump, the content of the recording information Sr is reflected. Consequently, while suppressing influence on continuity of the content at the time of reproduction of the recorded recording information Sr, the recording information Sr can be recoded in each of a number of recording layers L0 (L1)

Therefore, also in the case where there is the necessity of an interlayer jump in multi-recording layers, the recorded recording information Sr can be reproduced without giving any feeling of strangeness.

After the remaining recording capacity in the recording layer L0 becomes equal to or less than the threshold, the content of the recording information Sr is reflected in an interlayer jump. Consequently, while preventing the recording capacity of the recording layer L0 from being wasted, the content of the recording information Sr can be reflected at the time of an interlayer jump.

Further, the interlayer jump is performed at time (every hour, half past every hour, or the like) corresponding to a change in the content of the recording information Sr, the influence can be effectively suppressed on continuity of the content at the time of reproduction of the recording information Sr.

Further, since an interlayer jump is performed when silent time becomes longer than threshold time, the interlayer jump can be performed in a silent period in which it seems that there is no adverse effect even if reproducing process is temporarily interrupted.

Since an interlayer jump is performed when the attribute of sound of a program included in the broadcast program listing and the attribute of sound detected from the recording information Sr, the interlayer jump is performed during reproduction of, for example, commercial broadcasting. The interlayer jump can be performed at a timing which seems that there is no adverse effect even if reproducing process is temporarily interrupted.

Further, since an interlayer jump is performed when the whole image (picture) in consecutive plural images is switched, the interlayer jump can be performed in a period which seems that there is no adverse effect even if reproducing process is temporarily interrupted, such as a timing where a scene largely changes or a program itself is switched.

Further, an interlayer jump is performed at the time of a change in the aspect ratio or a change in content of copyright information at which the possibility of a change of a program is high. Consequently, the timing of a change of a program and an execution timing of the interlayer jump become the same, and the interlayer jump can be performed in a period in which there is no adverse effect even if the reproducing process is temporarily interrupted.

Since it can be set so that the interlayer jump is performed at an arbitrary timing of the user, the interlayer jump can be performed in consideration of both of the content of the recording information Sr and the switching timing set by the user.

Further, since the inhibition range of inhibiting the interlayer jump can be arbitrarily set by the user, the interlayer jump inhibition range can be set in accordance with the preference of the user or the like.

In the foregoing embodiment, the case of applying the present invention to the optical disk DK including the two recording layers L0 and L1 has been described. The present invention can be also applied to a control on an interlayer jump at the time of recording information to an optical disk having three or more recording layers.

It can be also set so as to forcedly perform the interlayer jump in accordance with an instruction of the user during recording of information to the optical disk DK. That is, it is also possible to display the remaining recording capacity of the recording layer L0 on the display unit 5 during recording of the information to the recording layer L0, so that the user can set a timing of performing an interlayer jump after that in accordance with the displayed remaining recording capacity by using the operation unit 6.

With the configuration, for example, in the case where it can be recognized from the display on the display unit 5 that there is hardly any remaining recording capacity in the recording layer L0 and information of one hour is going to be recorded on the optical disk DK, if recording is started from the recording layer L0, an interlayer jump occurs immediately after the start. Consequently, by the operation on the operation unit 6 of the user, the recording of information to the recording layer L0 is immediately finished, an interlayer jump is performed, and recording of the information of one hour is started from the recording layer L1.

Further, a program corresponding to the flowchart of FIG. 2 is recorded on an information recording medium such as a flexible disk or hard disk, or obtained via the Internet or the like and recorded. The recorded program is read and executed by a general computer. In such a manner, the computer can be utilized as the CPU of the embodiment.

1: An information recording apparatus for recording “recording information” to a recording medium having a plurality of recording layers, comprising:
a content detecting device which detects content of the recording information during recording of the recording information to one of the recording layers; and
a switching device which switches the recording layer to which the recording information is recorded from the one recording layer to another recording layer on the basis of the detected content, continues recording of the recording information.

2: The information recording apparatus according to claim 1,
further comprising a remaining recording capacity detecting device which detects whether or not remaining recording capacity in the one recording layer becomes equal to or less than a threshold which is preset on the basis of total recording capacity in the one recording layer,
wherein in a period after the remaining recording capacity becomes equal to or less than the threshold, the switching device switches the recording layer to which the recording information is recorded from the one recording layer to another recording layer based on the detected content, and continues recording the recording information.

3: The information recording apparatus according to claim 1,
wherein when it becomes prediction time which is predicted in advance as time corresponding to a timing at which the content changes, the switching device switches the recording layer to which the recording information is recorded from the one recording layer to another recording layer, and continues recording the recording information.

4: The information recording apparatus according to claim 1,
wherein the content is sound to be recorded as the recording information onto the recording medium, and
when time in which the sound in the recording information is absent becomes longer than preset threshold time, the switching means switches the recording layer to which the recording information is recorded from the one recording layer to another recording layer and continues recording of the recording information.

5: The information recording apparatus according to claim 1,
wherein the recording information is recording information including a program broadcasted on the basis of a predetermined broadcast schedule table,
the content is sound to be recorded as the broadcasted recording information onto the recording medium, and
when attribute of the sound included in the program scheduled in the broadcast schedule table and that of the detected sound are different from each other, the switching device switches the recording layer to which the recording information is recorded from the one recording layer to the another recording layer, and continues recording of the recording information.

6: The information recording apparatus according to claim 1,
wherein the content is an image to be recorded as the recording information onto the recording medium, and
when the entire image is switched in the plurality of continuous images in the recording information, the switching device switches the recording layer to which the recording information is recorded from the one recording layer to another recording layer, and continues recording of the recording information.

7: The information recording apparatus according to claim 1,
wherein the content is an image to be recorded as the recording information onto the recording medium, and
when an aspect ratio of the image changes in the plurality of continuous images in the recording information, the switching device switches the recording layer to which the recording information is recorded from the one recording layer to another recording layer and continues recording of the recording information.

8: The information recording apparatus according to claim 1,
wherein when the content of copyright management information for managing copyright corresponding to the recording information changes, the switching device switches the recording layer to which the recording information is recorded from the one recording layer to another recording layer, and continues recording of the recording information.

9: The information recording apparatus according to claim 1,
further comprising a setting device used for pre-setting the switching timing of switching from the one recording layer to another recording layer and continuing recording of the recording information,
wherein when it becomes to the set switching timing during recording of the recording information onto the one recording layer, the switching device switches the recording layer to which the recording information is recorded from the one recording layer to another recording layer, and continues recording of the recording information.

10: The information recording apparatus according to claim 1, further comprising:
an inhibition range setting device used for setting a range of the recording information in which switching of the recording layer during recording of the recording information onto the recording medium is inhibited; and
a control device which controls the switching means so as to inhibit the switching during recording of the recording information included in the range.

11: An recording medium where an information recording program is recorded so as to be readable by a computer included in an information recording apparatus for recording “recording information” to a recording medium having a plurality of recording layers, said information recording program making the computer function as:
a content detecting device which detects content of the recording information during recording of the recording information to one of the recording layers; and
a switching device which switches the recording layer to which the recording information is recorded from the one recording layer to another recording layer on the basis of the detected content, and continues recording of the recording information.
